(19) United States
(12) Patent Application Publication
(10) Pub. No.: US 2023/0126708 A1
(43) Pub. Date: Apr. 27, 2023

(54) ARTIFICIAL INTELLIGENCE BASED METHODS AND SYSTEMS FOR REMOVING TEMPORAL BIASES IN CLASSIFICATION TASKS

(71) Applicant: MASTERCARD INTERNATIONAL INCORPORATED, Purchase, NY (US)

(72) Inventors: Hardik Wadhwa, Sirsa (IN); Anubhav Gupta, Lucknow (IN); Aditya Singh, Ramnagar (IN); Siddhartha Asthana, New Delhi (IN); Ankur Arora, New Delhi (IN)

(73) Assignee: MASTERCARD INTERNATIONAL INCORPORATED, Purchase, NY (US)

(21) Appl. No.: 18/049,171

(22) Filed: Oct. 24, 2022

(30) Foreign Application Priority Data
Oct. 25, 2021 (IN) 202141048722

(51) Int. Cl. G06Q 20/40; G06Q 20/06

(52) U.S. Cl. CPC G06Q 20/4016; G06Q 20/0658; G06Q 2220/00

(57) ABSTRACT

Embodiments provide methods and systems for removing temporal biases in classification tasks. Method performed by server system includes accessing a transaction graph associated with a particular time duration and determining a set of local features and aggregate features associated with each node based on labeled data. Method includes generating via a machine learning model, a set of intermediate node representations associated with each of the plurality of nodes based on the set of local features and the set of aggregate features. Method includes generating via a fraud model and a timestep model, a fraud classification loss, and a timestep classification loss based on the set of intermediate node representations. Method includes determining an adversarial loss value based on the fraud classification loss and the timestep classification loss. Method includes determining a set of optimized parameters for the machine learning model based on the adversarial loss value.

### TECHNICAL FIELD

The present disclosure relates to artificial intelligence processing systems and, more particularly to, electronic methods and complex processing systems for removing temporal biases in data features to improve model performance for a classification task. In one practical application, the present disclosure discloses methods and systems for detecting illicit digital asset transactions performed over a blockchain payment network.

### BACKGROUND

A bias in an artificial intelligence model is defined as the principle of observing results that are prejudiced due to faulty assumptions. Sometimes, machine learning models become temporally biased to specific prediction results since these models are trained during a particular timestep that might introduce this bias. The term ‘timestep’ may be defined as the time interval during which transaction data is recorded. For example, a timestep of 3 hours will record transaction information for all of the transactions performed with a payment processor during those 3 hours. Conventionally, machine learning techniques such as tree-based models, anomaly detection, and advanced graph-based deep learning techniques have been utilized to detect illicit or fraudulent digital asset transactions in transaction datasets. In an example, illicit digital asset transactions may include money laundering, terrorist financing, illegal and risky services, Ponzi schemes, and the like.

The training methodologies in the above techniques, i.e., training with data of initial timesteps and testing on remaining timesteps, result in the model learning fraud patterns dependent on timesteps (corresponding to the training data) instead of underlying fraud patterns that do not have a bias for specific timesteps. For example, if the model is trained on 5 different timesteps when high volume transactions are common (in scenarios such as a cryptocurrency exchange being compromised) then, the model may mislabel a future high volume transaction in a 6^{th} timestep as licit as opposed to being illicit. Thus, the model may be described as a temporally biased model and this model faces timestep dependency and raises the challenge of generalization. Further, the model performance on payment transactions in future timesteps is reduced.

Thus, there exists a technological need for technical solutions for mitigating temporal biases in machine learning models.

### SUMMARY

Various embodiments of the present disclosure provide artificial intelligence based methods and systems for removing temporal biases in classification tasks.

In an embodiment, a computer-implemented method for removing temporal biases in machine learning models is disclosed. The computer-implemented method performed by a server system includes accessing a transaction graph associated with a particular time duration from a database. The transaction graph includes a plurality of nodes and a plurality of edges. The plurality of nodes indicates a plurality of transactions and the plurality of edges indicates different entities involved in the plurality of transactions. The method includes determining a set of local features and a set of aggregate features associated with each node of the transaction graph based, at least in part, on labeled data associated with the each node. Further, the method includes generating via a machine learning model, a set of intermediate node representations associated with each of the plurality of nodes based, at least in part, on the set of local features and the set of aggregate features. Further, the method includes generating via a fraud model and a timestep model, a fraud classification loss, and a timestep classification loss based, at least in part, on the set of intermediate node representations. Further, the method includes determining an adversarial loss value based, at least in part, on the fraud classification loss and the timestep classification loss. Further, the method includes determining a set of optimized parameters for the machine learning model based, at least in part, on the adversarial loss value.

In another embodiment, a server system is disclosed. The server system includes a communication interface and a memory including executable instructions. The server system also includes a processor communicably coupled to the memory. The processor is configured to execute the instructions to cause the server system, at least in part, to access a transaction graph associated with a particular time duration from a database. The transaction graph includes a plurality of nodes and a plurality of edges. The plurality of nodes indicates a plurality of transactions and the plurality of edges indicates different entities involved in the plurality of transactions. The server system is further caused to determine a set of local features and a set of aggregate features associated with each node of the transaction graph based, at least in part, on labeled data associated with the each node. The server system is further caused to generate via a machine learning model, a set of intermediate node representations associated with each of the plurality of nodes based, at least in part, on the set of local features and the set of aggregate features. The server system is further caused to generate via a fraud model and a timestep model, a fraud classification loss, and a timestep classification loss based, at least in part, on the set of intermediate node representations. The server system is further caused to determine an adversarial loss value based, at least in part, on the fraud classification loss and the timestep classification loss. The server system is further caused to determine a set of optimized parameters for the machine learning model based, at least in part, on the adversarial loss value.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a transaction graph associated with a particular time duration from a database. The transaction graph includes a plurality of nodes and a plurality of edges. The plurality of nodes indicates a plurality of transactions and the plurality of edges indicates different entities involved in the plurality of transactions. The method includes determining a set of local features and a set of aggregate features associated with each node of the transaction graph based, at least in part, on labeled data associated with the each node. Further, the method includes generating via a machine learning model, a set of intermediate node representations associated with each of the plurality of nodes based, at least in part, on the set of local features and the set of aggregate features. Further, the method includes generating via a fraud model and a timestep model, a fraud classification loss, and a timestep classification loss based, at least in part, on the set of intermediate node representations. Further, the method includes determining an adversarial loss value based, at least in part, on the fraud classification loss and the timestep classification loss. Further, the method includes determining a set of optimized parameters for the machine learning model based, at least in part, on the adversarial loss value.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some example embodiments of the present disclosure;

FIG. 2 illustrates an exemplary representation of an environment related to at least some example embodiments of the present disclosure;

FIG. 3 illustrates a simplified block diagram of a server system, in accordance with an embodiment of the present disclosure;

FIG. 4 illustrates schematic block diagram representation of various models for detecting illicit digital asset transactions, in accordance with an embodiment of the present disclosure;

FIG. 5 illustrates a method for removing temporal biases in detecting illicit transactions, in accordance with an embodiment of the present disclosure;

FIG. 6 is a method for determining fraudulent cryptocurrency payment transactions, in accordance with an embodiment of the present disclosure;

FIG. 7 illustrates a method for removing temporal biases in detecting illicit transactions, in accordance with another embodiment of the present disclosure;

FIGS. 8A and 8B, collectively illustrate a comparative result analysis of the baseline model (i.e., prior art or conventional technique) in combination with a random forest based learning technique;

FIG. 9A shows a comparative result analysis of illicit classification results from experiments using prior-art models with its combination of features and node embeddings and the proposed model (i.e., the detection model in accordance with the present disclosure) with its combination of features and node embeddings; and

FIG. 9B depicts a graphical representation of the model performance of the classification model at different timesteps, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term ‘blockchain payment network’ may refer to one or more server computers that function to operate and maintain the operation of a digital asset such as cryptocurrency or a cryptocurrency system. The blockchain payment network may function to facilitate the generation, issuance, and distribution of digital currency among two or more server computers within the blockchain payment network. The blockchain payment network may also function to enable the performance of transactions between the server computers for the transfer or goods/services and/or the transfer of funds. The blockchain payment network may include one or more server computers implementing issuer nodes and distributor nodes. Each issuer node and distributor node may be a server computer associated with a separate financial institution (i.e., each issuer node may be associated with a central bank, federal reserve, or government authority, while each distributor node may be associated with a different commercial bank). Hereinafter, the terms ‘blockchain-based network’, ‘blockchain-based payment network’, and ‘blockchain network’ may be used interchangeably with the term ‘blockchain payment network’.

The term ‘blockchain’ refers to a type of distributed ledger technology (DLT) that consists of a growing list of records, known as blocks, that are securely linked together using cryptography. Each block contains a cryptographic hash of the previous block, a timestamp, and payment transaction data. The timestamp proves that the transaction data existed when the block was created. Since each block contains information about the block previous to it, they effectively form a chain with each additional block linking to the ones before it. Digital asset transactions are generally performed over a blockchain network since the blocks on the blockchain are considered to be secure and immutable. Blockchains are typically managed by a peer-to-peer (P2P) computer network for use as a public distributed ledger, where nodes collectively adhere to a consensus algorithm protocol to add and validate new transaction blocks.

The term ‘digital asset’ may generally refer to anything that is created and stored digitally, is identifiable and discoverable, and has or provides value. Some examples of digital assets may include cryptocurrency (such as Bitcoin), Non-Fungible Tokens (NFTs), Utility tokens, Security tokens, and the like. A customer may pay for a service or product offered by a merchant either using the digital asset or by exchanging the digital asset with a Fiat currency (i.e., government-issued currency such as US dollars and the like) and paying the merchant via the Fiat currency.

To that end, a digital asset such as a cryptocurrency is a digital payment system that doesn't rely on banks to verify transactions. It's a peer-to-peer system that can enable any user having a blockchain or cryptocurrency account anywhere to send and receive payments. Instead of being physical money carried around and exchanged in the real world, digital asset payments exist purely as digital entries to an online database describing specific transactions. When an account transfers digital asset funds to another account, the transactions are recorded in a distributed public ledger, and a record of all transactions is updated and held by account holders. The cryptocurrency is stored in digital wallets and it uses encryption to verify transactions. The cryptocurrency uses advanced coding in storing and transmitting cryptocurrency data between the wallets and the public ledgers. The blockchain payment network requires minimal structure to share transactions. Typically an Adhoc decentralized network of volunteers is sufficient. The messages are broadcast on a best-effort basis, and nodes can leave and rejoin the network at will. Upon reconnection, a node downloads and verifies new blocks from other nodes to complete its local copy of the blockchain.

### Overview

Various embodiments of the present disclosure provide methods, systems electronic devices, and computer program products for removing temporal biases from machine learning models. It should be noted that although various exemplary embodiments of the present disclosure are described herein with reference to cryptocurrency transactions in a blockchain payment network, the various embodiments of the present disclosure are applicable in other suitable networks for any digital asset transaction as well.

Conventional cryptocurrency fraud detection or classification models have various limitations or drawbacks. For example, the conventional graph representation learning models are timestep dependent and thus, provide classifications with temporal bias, i.e., inaccurate classifications. These conventional fraud detection techniques use graph-based deep learning methods to generate node embeddings from a transaction graph. These embeddings are then used for detecting illicit or fraudulent transactions. Various methods such as DeepWalk and node2vec are used to generate these node embeddings, which are then used to detect fraud or illicit transactions in the transaction graph. However, it should be noted that such techniques suffer from a temporal bias that leads to a collapse of the model, i.e., the model fails to label the transaction correctly as time passes.

To overcome such problems or limitations, the present disclosure describes a server system that is configured to perform the below operations.

The server system includes at least a processor and a memory. In one non-limiting example, the server system is a payment server. The server system is configured to access a transaction graph associated with a particular time duration from a database. The transaction graph may include a plurality of nodes and a plurality of edges. The plurality of nodes may correspond to a plurality of transactions and the plurality of edges may correspond to different entities involved in the plurality of transactions. In a non-limiting example, the plurality of transactions may be digital asset transactions performed over a blockchain network. In one example, the different entities may include cardholders, merchants, authors, users, companies, organizations, and the like that hold accounts in the blockchain network. In one non-limiting example, the transactions may be historical transactions that have been performed on the blockchain network. These historical transactions may have been performed between a plurality of accounts associated with a plurality of users and a plurality of accounts associated with a plurality of merchants over a period of time (e.g., 1 year, 2 years, 5 years, etc.).

In one embodiment, the nodes of the transaction graph are account addresses, and the edges are the transactions between these accounts. In another embodiment, each node of the transaction graph consists of a set of information associated with the corresponding node. This set of information indicates the label data of the node and may include temporal information of the transaction and the temporal information is encoded by a timestep (i.e., a measure of the actual transaction time stamp). The timesteps are evenly spaced with an interval of a particular time, each of them contains a single connected component of transactions that appeared on the blockchain within the particular time interval (such as less than three hours) between each other. It should be noted that to make a transaction graph from digital asset transaction data, one edge from each input address and to each output address in transactions in the graph is created. For example, if ‘A’ sends a digital asset to ‘B’ and ‘B’ sends it to ‘C’, then the input address may refer to the address of ‘A’, and the output address may refer to the address of ‘C’. The time dependency of the temporal graph is defined based on features such as cycles (refers to a closed loop of nodes in a graph) and out-degree of nodes.

The server system is configured to determine a set of local features and a set of aggregate features associated with each node of the transaction graph based, at least in part, on labeled data associated with the each node. The labeled data includes at least a set of information associated with each of the plurality of nodes. In one embodiment, the plurality of transaction features is divided into local features of the transaction and non-local (i.e., graph) information in the form of aggregated features. In other words, the aggregated features are formed using information one-hop backward/forward from the transaction node. In a non-limiting example, the set of local features may include at least timestep information, transaction fee, number of inputs or outputs, output volume, average asset amount received by the input or output, and average incoming transactions associated with the input or output, and the like. In an embodiment, the set of aggregate features is determined based, at least in part, on transaction information of one transaction backward and forward from each of the plurality of transactions. In another non-limiting example, the set of aggregate features may include at least maximum deviation, minimum deviation, standard deviation, and correlation coefficients of the neighbor transactions for each of the set of local features.

The server system is configured to generate via a machine learning model, a set of intermediate node representations associated with each of the plurality of nodes based, at least in part, on the set of local features and the set of aggregate features. Further, the server system is configured to generate via a machine learning model, a set of intermediate node representations associated with each of the plurality of nodes based, at least in part, on the set of local features and the set of aggregate features. In an embodiment, the machine learning model is a graph machine learning (GNN) model trained in an adversarial manner.

The server system is configured to generate via a fraud model (or fraud classifier) and a timestep model (or timestep classifier), a fraud classification loss, and a timestep classification loss based, at least in part, on the set of intermediate node representations. In one embodiment, the task-specific classification loss is a loss function of the fraud classifier and the timestep classification loss is a loss function of the timestep classifier. In an embodiment, the fraud model and the timestep model are fully-connected layer based classification models with a softmax layer. In an embodiment, the fraud model classifies the input cryptocurrency payment transaction data into licit or illicit transactions and generates a certain fraud classification loss during the process. In another embodiment, the timestep model classifies the timestep incorrectly and generates timestep classification loss in the process.

Further, the server system is configured to determine an adversarial loss value based, at least in part, on the fraud classification loss and the timestep classification loss. In an embodiment, determining the adversarial loss value includes iteratively performing the following operation till the performance of the timestep model is greater than a predetermined threshold. The operation includes generating, a reverse gradient polarity of the timestep classification loss, i.e., a negated loss value, and then, back-propagating a combination of the fraud classification loss and the reverse gradient polarity of the timestep classification loss to optimize the adversarial loss value.

Further, the server system is configured to determine a set of optimized parameters for the machine learning model based, at least in part, on the adversarial loss value. In an embodiment, the server system is configured to generate an optimized machine learning model from the machine learning model based, at least in part, on the set of optimized parameters. In a non-limiting example, the optimized machine learning model may be an optimized GNN model. It should be noted that an incorrect timestep classification will force the GNN model to learn the underlying fraud patterns in transaction graph data thereby, making the GNN model temporally robust and unbiased. In one embodiment, the GNN feature extractor is trained by fine-tuning the weights based on backpropagation values from the previous epoch of the fraud model and the timestep model.

The server system is configured to generate via the optimized machine learning model, a set of updated intermediate node representations associated with each of the plurality of nodes based, at least in part, on the set of local features and the set of aggregate features. Further, the server system is configured to classify via the fraud model, a transaction as one of a licit and an illicit transaction based, at least in part, on the set of updated intermediate node representations.

To that end, the proposed methods and systems generate a machine learning model (i.e., the GNN model) or train the existing model in an adversarial manner to determine fraudulent transactions. In one embodiment, the GNN-based model is trained without any temporal bias. Therefore, the proposed methods and systems provide an accurate classification and determination of fraud labels (i.e., licit or illicit labels), and an increase in the performance of the machine learning model.

Various embodiments of the present disclosure offer multiple advantages and technical effects. For instance, the present disclosure employs multiple strategies to ensure the classification of the transactions as licit or illicit in a temporally unbiased manner. The present disclosure includes an adversarial loss function that incorporates these strategies and optimizes the machine learning model so that it learns effectively. In other words, the adversarial loss function ensures that the learned representation is optimal even though the transaction graphs are temporally biased and the problem is unsupervised. The cumulative loss function incorporates local and aggregated graph learning components that make the proposed algorithm effective even in the absence of node labels. Thus, the proposed solution provides a strategy to ensure that the classification of fraudulent transactions is temporally unbiased and independent.

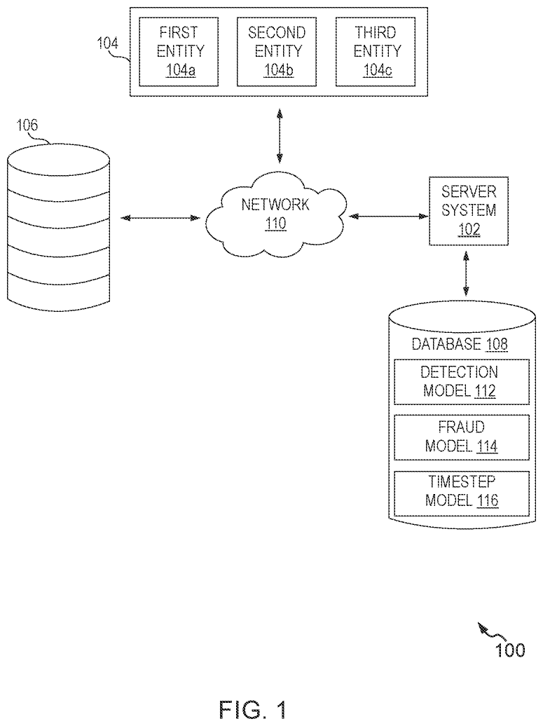

Various example embodiments of the present disclosure are described hereinafter with reference to FIGS. 1 to 9A-9B.

FIG. 1 illustrates an exemplary representation of an environment 100 related to at least some example embodiments of the present disclosure. Although the environment 100 is presented in one arrangement, other embodiments may include the parts of the environment 100 (or other parts) arranged otherwise depending on, for example, removing temporal biases in data features to improve the model performance of a machine learning model in performing classification task, etc. The problem of temporal biasing is modeled using domain adaptation over different timesteps and this temporal biasing is later captured and then, removed using the improved machine learning model of the present disclosure.

The environment 100 generally includes a server system 102, a plurality of entities 104a, 104b, and 104c (collectively represented as entity 104), and a data source 106, each coupled to, and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 1, or any combination thereof.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 110 may include multiple different networks, such as a private network made accessible by the server system 102 and a public network (e.g., the Internet, etc.) through which the server system 102 may communicate.

Examples of the plurality of entities 104a, 104b, and 104c are, but are not limited to, a customer, a merchant, a third party user, medical facilities (e.g., hospitals, laboratories, etc.), financial institutions, educational institutions, government agencies, and telecom industries. In addition, each entity of the plurality of entities may interact with each other, i.e., each entity of the plurality of entities may be associated (in some way or the other) or interact with the other entity of the plurality of entities 104. In a non-limiting example, the entities 104 may be responsible for performing a plurality of digital asset transactions. In an example, a payment processor may facilitate the entity 104 to transact digital assets such as cryptocurrencies.

The data source 106 may include, but is not limited to, entity datasets. The data source 106 consists of multiclass entity datasets derived from the plurality of entities 104. In one embodiment, the plurality of entities 104 is a plurality of accounts such as cryptocurrency wallets. In one example, the multiclass entity datasets include fraudulent or illicit transaction datasets, non-fraudulent or licit transaction datasets, and unknown datasets.

In one embodiment, the server system 102 is configured to perform one or more of the operations described herein. The server system 102 is configured to extract features from a transaction database to use them as an input to a detection model 112. In an embodiment, the detection model 112 may be an Artificial Intelligence (AI) model or a machine learning (ML) model. In a non-limiting example, the detection model 112 may be a graph neural network (GNN) model that is trained using an adversarial architecture. The GNN model can generalize the entity datasets and the adversarial loss architecture of the GNN model ensures that the model learns to generalize on different domains by capturing the underlying pattern in the data.

To that end, the server system 102 utilizes the detection model 112 which may generate temporal unbiased features that generalize well over the different timesteps. In general, the server system 102 is configured to remove the temporal biases in the classification tasks to accurately classify a transaction as either licit or illicit. In one embodiment, the database 108 is configured to store the detection model 112, a fraud model 114, and a timestep model 116.

In an embodiment, the fraud model 114 is a fully connected (fc) neural network classifier that classifies the data of the entities 104 into one or more classes. In an embodiment, the timestep model 116 is a fully connected (fc) neural network classifier that classifies temporal data or time-based data of the entity 104 incorrectly. In an embodiment, the detection model 112 inputs raw feature data of the entities 104 and learns a set of intermediate node representations or hidden layer representations and generates feature-rich data which is fed into the fraud model 114 and the timestep model 116.

It should be understood that the server system 102 is a separate part of the environment 100, and may operate apart from (but still in communication with, for example, via the network 110) any third-party external servers (to access data to perform the various operations described herein). However, in other embodiments, the server system 102 may be incorporated, in whole or in part, into one or more parts of the environment 100. In addition, the server system 102 should be understood to be embodied in at least one computing device in communication with the network 110, which may be specifically configured, via executable instructions, to perform steps as described herein, and/or embodied in at least one non-transitory computer-readable media.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

In a non-limiting example, the present disclosure explains methods and systems for improving the performance of a machine learning model (i.e., a classification model) to detect illicit digital asset transactions in the following disclosure. The improvement in performance is achieved by removing temporal bias in the conventional machine learning models while examining and learning using digital asset transaction datasets. The present disclosure describes generating a new or training an existing artificial intelligence model or a machine learning model (referred to hereafter as ‘detection model’) in a temporal de-bias manner which mitigates timestep bias in the detection model 112, thereby, increasing the performance in future timesteps while determining fraudulent or illicit transactions. The timestep model is introduced to mitigate timestep bias while training the detection model. The proposed methods and systems train the detection model 112 (such as a graph neural network (GNN) based feature extractor) using an adversarial architecture. The adversarial architecture operates by employing the fraud model 114 and the timestep model 116. In the adversarial architecture, the fraud model 114 helps to optimize the detection model 112 by classifying fraud or illicit labels of a plurality of transactions correctly and the timestep model 116 optimizes the detection model 112 by classifying the timestep incorrectly. This forces the detection model to learn the underlying fraud patterns in the plurality of digital asset transactions. Since the timesteps are classified incorrectly and the detection model 112 learns the fraud patterns, the detection model 112 becomes temporally robust and unbiased detection, therefore, improving the capability of the detection model 112 in detecting fraudulent transactions. The present disclosure allows training of the detection model 112 without any temporal bias. The proposed disclosure provides accurate classification and determination of fraud labels, and an increase in the performance of classification operations. The detection model 112 generates temporally unbiased features, resulting in better overall performance for future or unseen timesteps.

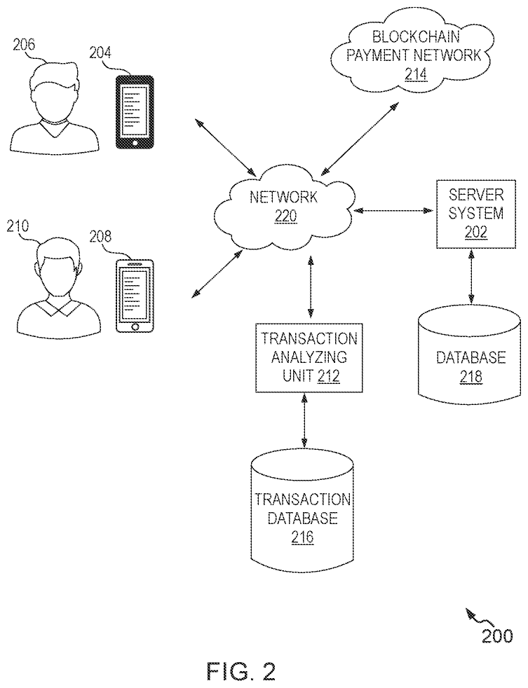

FIG. 2 illustrates an exemplary representation of an environment 200 related to at least some example embodiments of the present disclosure. Although the environment 200 is presented in one arrangement, other embodiments may include the parts of the environment 200 (or other parts) arranged otherwise depending on, for example, identifying fraudulent digital asset transactions, etc. The environment 200 generally includes a server system 202, a user device 204 associated with a user, a merchant device 208 associated with a merchant 210, a transaction analyzing unit 212, blockchain payment network 214 each coupled to, and in communication with (and/or with access to) a network 220. The network 220 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 2, or any combination thereof. For simplicity of illustration, a certain number of components are shown in FIG. 2. It is understood, however, that embodiments of the invention may include more than one of each component. In addition, some embodiments of the invention may include fewer than or greater than all of the components shown in FIG. 2. Thus, in FIG. 2, the number of users and merchants included in various embodiments is flexible.

Various entities in the environment 200 may connect to the network 220 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 220 may include multiple different networks, such as a private network made accessible by the server system 202 and a public network (e.g., the Internet, etc.) through which the server system 202, the merchant device 208, the user device 204, and the transaction analyzing unit 212 may communicate.

In one embodiment, the user 206 may be any individual, representative of a corporate entity, non-profit organization, or any other person. In one embodiment, the user 206 may have a relationship with the blockchain payment network 214. The user 206 may be associated with a user device 204 and may use an application installed on the user device 204 to initiate or engage in a digital asset transaction with any merchant. In various non-limiting examples, the application may be a digital asset wallet application (such as a wallet issued by a cryptocurrency and NFT exchange and the like), a blockchain marketplace, a Decentralized Finance (Defi) application, a web browser, an eCommerce application, and the like.

In one embodiment, the merchant 210 may be any individual, representative of a corporate entity, non-profit organization, or any other person. In an embodiment, the merchant 210 may have a relationship with the blockchain payment network 214. The merchant 210 may receive a digital asset from the merchant 210 against a purchase transaction when the purchase transaction is settled. The merchant 210 may be associated with a merchant device 208 and may use an application installed on the merchant device 208 to receive the digital asset when the payment transaction is settled. In various non-limiting examples, the application may be a digital asset wallet application (such as a wallet issued by a cryptocurrency and NFT exchange and the like), a blockchain marketplace, a Decentralized Finance (Defi) application, a web browser, an eCommerce application, and the like. The merchant 210 is the company that is ultimately responsible for the financial transaction. Examples of the merchant 210 may include any retail shop, restaurant, supermarket or establishment, government and/or private agencies, or any such place where customers visit for performing digital asset transactions in exchange for any goods and/or services or any transaction that requires financial transaction between user 206 and the merchant 210.

Examples of the user device 204 or the merchant device 208 may include, without limitation, a smart phone, a tablet computer, other handheld computers, wearable devices, laptop computers, desktop computers, servers, portable media players, gaming devices, and so forth. In one embodiment, the user device 204 is installed with a cryptography exchange application or wallet hosting facilities for exchanging digital assets into another form of coin or currency such as FIAT currency. In one example, the user 206 and the merchant 210 are associated with accounts holding their digital assets.

In one embodiment, the transaction analyzing unit 212 models transactions associated with digital assets occurring over the blockchain payment network 214. The transaction analyzing unit 212, for example, may monitor for suspicious or illicit transactions occurring over the blockchain payment network 214. In one embodiment, the transaction analyzing unit 212 may connect with some APIs that enforce modeling of the digital asset transaction data across various transaction attributes. In one embodiment, the transaction analyzing unit 212 generates a transaction graph based on transaction metadata associated with digital asset transactions. In one embodiment, the transaction analyzing unit 212 is coupled with a transaction database 216 to store the modeled transactions associated with digital transactions and the transaction graphs. In one embodiment, the blockchain payment network 214 is a peer-to-peer payment network that operates on a cryptographic protocol.

For example, the transaction analyzing unit 212 may create a sub-graph of a bitcoin transaction graph (i.e., directed acyclic graph (DAG)). As may be understood, anyone running a bitcoin node has access to all the transactions in the blockchain (since all the transaction history is public and available to anyone on the bitcoin blockchain) and can therefore build the bitcoin transaction graph from it. In general, in a transaction graph, nodes are account addresses, and the edges are the transactions between different accounts of different entities (such as user 206 and merchant 210). Therefore, given that each block of the blockchain has a timestamp, the transaction analyzing unit 212 divides the timeline into regular intervals and creates a transaction graph for a particular time duration. For example, the transaction graph may be generated at monthly intervals for each month that only includes the digital asset transactions in the blocks of that month.

Further, based on the graph information, the transaction analyzing unit 212 categorizes the nodes (i.e., digital asset transaction) of the graph into three classes: “licit”, “illicit” or “unknown”. In an example, a node is deemed to be “licit” or “illicit” when the corresponding transaction has been created by an entity that belongs to a licit category (exchanges, wallet providers, miners, financial service providers, etc.) or an illicit category (e.g., scams, malware, terrorist organizations, ransomware, Ponzi schemes, etc.) respectively. Therefore, the dataset is used to classify the illicit and licit nodes, given a set of features and the graph topology. It should be noted that the in-degree to a transaction node represents a number of inputs of a transaction and the out-degree represents a number of outputs that have been spent. The dataset also partially labels the transaction into two categories “licit” and “illicit”.

It should be understood that each node of the transaction graph consists of a set of information associated with the corresponding transaction. This set of information indicates the label data of the node and may include temporal information of the transaction and the temporal information is encoded by a time step (i.e., a measure of the actual transaction time stamp). The time steps are evenly spaced with an interval of a particular time, each of them contains a single connected component of transactions that appeared on the blockchain within the particular time interval (such as less than three hours) between each other. It should be noted that to make a transaction graph from a set of historical digital asset transactions, one edge from each input address and to each output address in transactions in the graph is created. For example, if ‘A’ sends a digital asset to ‘B’ and ‘B’ sends it to ‘C’, then the input address may refer to the address of ‘A’, and the output address may refer to the address of ‘C’. The time dependency of the temporal graph is defined based on features such as cycles (refers to a closed loop of nodes in a graph) and out-degree of nodes. For example, if there are a total of 49 different timesteps ranging from 1 to 49, then, each timestep is taken within two weeks of separation and records transactions of less than 3 hours. It should be noted that apart from the timestep, all the other features associated with the node are anonymized.

Consequently, the transaction analyzing unit 212 is configured to generate a plurality of transaction graphs based on digital asset transactions performed over the blockchain payment network 214 in different timesteps. The transaction analyzing unit 212 is configured to implement various machine learning models.

A plurality of transaction features is created corresponding to each node. The plurality of transaction features is divided into a set of local features of the transaction and non-local (i.e., graph) information in the form of a set of aggregated features. In a non-limiting example, the set of local features may include at least timestep information, transaction fee, number of inputs or outputs, output volume, average asset amount received by the input or output, average incoming transactions associated with the input or output, and the like. In an embodiment, the set of aggregate features is determined based, at least in part, on transaction information of one transaction backward and forward from each of the plurality of nodes. In another non-limiting example, the set of aggregate features may include at least maximum deviation, minimum deviation, standard deviation, and correlation coefficients of the neighbor transactions for each of the local features.

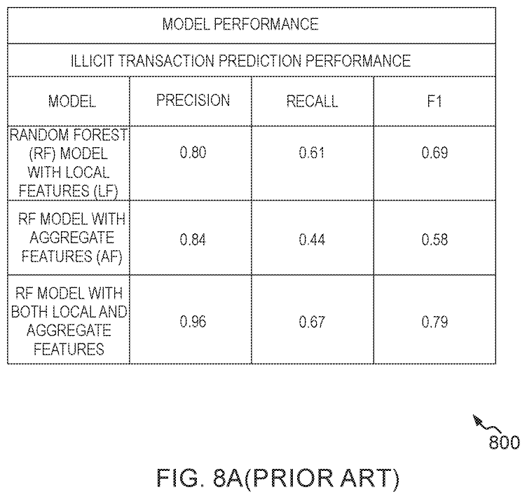

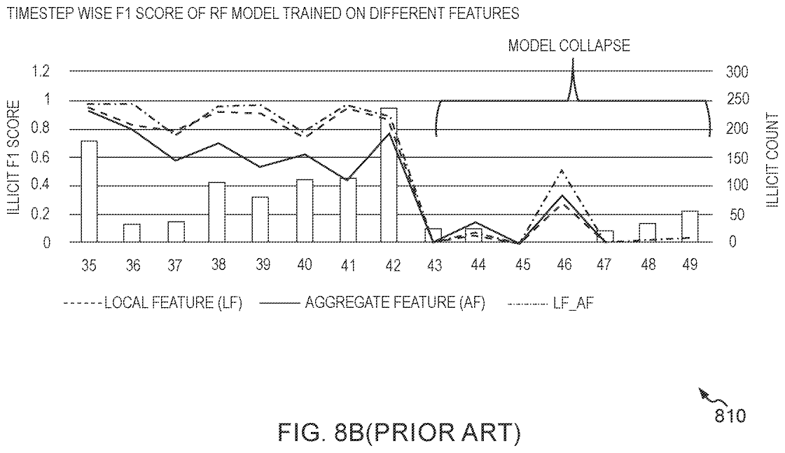

It should be noted that the cycles and out-degree features often play a major role in determining illicit activities like money laundering in the blockchain payment network 214. To inspect time dependency or temporal bias in the set of local and the set of aggregated features of the transaction graphs, a machine learning model such as a classification model (such as a random forest model) is trained and the results (as shown in the FIGS. 8A and 8B) are analyzed.

Referring now to FIGS. 8A and 8B, a comparative result analysis of the baseline model (i.e., prior art or conventional technique) in combination with a random forest based learning technique are shown. In an example, FIG. 8A provides a result table 800 for illicit transaction performance of the baseline model and FIG. 8B provides a graphical representation 810 of the performance of the baseline model from the 35^{th} timestep to the 49^{th} timestep. Here, the baseline model utilizes random forest techniques with a set of local and a set of aggregated features to train the model to classify illicit digital asset transactions. The baseline model uses transaction data from 49 different timesteps. The baseline model is first trained on the transaction data associated with 34 timesteps and tested using the transaction data associated with timesteps 35-49. The baseline model with the set of local features provides a precision of 0.80 and an F1 score of 0.69 as the result of the experiment. Further, the baseline model with the set of aggregated features provides a precision of 0.84 and an F1 score of 0.58, and the baseline model with both the set of local features and the set of aggregated features provides a precision of 0.96 and an F1 score of 0.79 as a result of the experiment. However, during the experiment, it is noted that the baseline model in all three scenarios fails to generalize the model from the 43^{rd} timestep onwards (see, FIG. 8B). That is, the baseline model fails to label the transaction correctly as time passes. The illicit F1 score of the baseline model without the set of aggregated features drops by 10%, whereas the illicit F1 score of the baseline model without the set of local features drops by 21%. Further, from the results, it can be derived that the set of aggregated features has less predictive power than that of the set of local features. FIG. 8B depicts a graphical representation 810 on how the model collapses after the 43^{rd} timestep and shows the reduction in the performance of prediction of illicit transaction count.

Hence, it is evident that the set of local features and the set of aggregated features of the transaction graphs are temporally biased, i.e., these features are timestep dependent. Moreover, it is noted that the set of aggregated features is highly biased. Thus, using the aggregated features for predicting illicit digital asset transactions in any classification model would degrade the model performance in future timesteps.

Referring now back to FIG. 2, to mitigate the above technical problem in detecting illicit digital asset transactions, the server system 202 is configured to perform one or more of the operations described herein. In one example, the server system 202 coupled with a database 218 is connected with the blockchain payment network 214. In general, the server system 202 is configured to utilize machine learning models to determine illicit or fraudulent transactions. In an embodiment, the server system 202 utilizes a detection model (such as detection model 112 of FIG. 1) that may be a graph neural network (GNN) model trained with an adversarial loss architecture to generate temporal unbiased features. The detection model 112 generalizes well over the different timesteps. The server system 202 is a separate part of the environment 200, and may operate apart from (but still in communication with, for example, via the network 220) any third-party external servers (to access data to perform the various operations described herein). However, in other embodiments, the server system 202 may be incorporated, in whole or in part, into one or more parts of the environment 200. In addition, the server system 202 should be understood to be embodied in at least one computing device in communication with the network 220, which may be specifically configured, via executable instructions, to perform steps as described herein, and/or embodied in at least one non-transitory computer-readable media.

In one embodiment, the blockchain payment network 214 may be based on blockchain-based networks such as Bitcoin™, and Ethereum™, and used by transaction nodes (i.e., financial entities) to perform various digital asset-based transactions. In an embodiment, the blockchain payment network 214 may be associated with a payment processor such as Mastercard™, and the like. In one example, the payment processor may convert the digital assets of the user 206 into fiat currency according to an exchange rate before settling the payment with the merchant 210 in fiat currency. In another example, the payment processor may convert the digital assets of the user 206 into another digital asset according to an exchange rate before settling the payment with the merchant 210 in their desired digital asset. For example, if a user is performing a transaction using an NFT, the payment processor may sell the NFL at a digital asset marketplace and settle the payment with the merchant in their desired digital asset (such as a cryptocurrency like bitcoin).

The number and arrangement of systems, devices, and/or networks shown in FIG. 2 are provided as an example. There may be additional systems, devices, and/or networks; fewer systems, devices, and/or networks; different systems, devices, and/or networks; and/or differently arranged systems, devices, and/or networks than those shown in FIG. 2. Furthermore, two or more systems or devices shown in FIG. 2 may be implemented within a single system or device, or a single system or device shown in FIG. 2 may be implemented as multiple, distributed systems or devices. Additionally, or alternatively, a set of systems (e.g., one or more systems) or a set of devices (e.g., one or more devices) of the environment 200 may perform one or more functions described as being performed by another set of systems or another set of devices of the environment 200.

The present disclosure also provides a detailed study of different techniques that can be used with GNNs to extract feature-rich datasets from the graphical data representations and to differentiate and determine the licit and illicit transaction datasets among the feature-rich datasets by removing temporal bias in the prediction tasks. It should be noted that extensive experiments have been conducted on publicly available transaction datasets to verify the various techniques of the present disclosure. The results of these experiments show an absolute improvement of 5% in Recall and 1% in the F1-score in the performance of the fraud model 114 in determining illicit transactions.

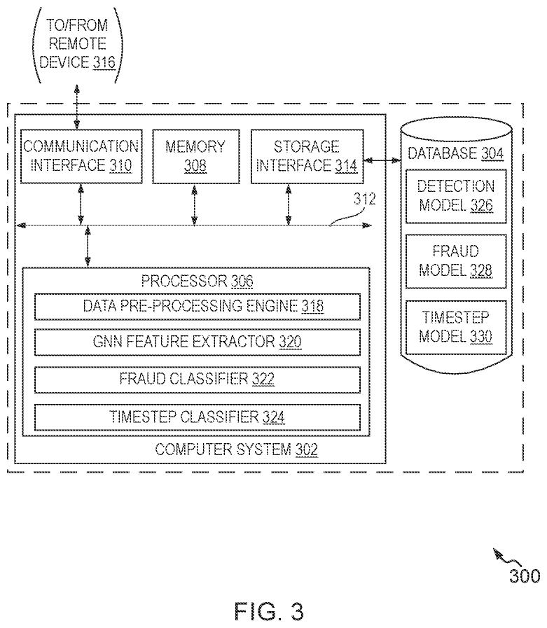

Referring now to FIG. 3, a simplified block diagram of a server system 300 is illustrated, in accordance with an embodiment of the present disclosure. The server system 300 is similar to the server system 102 and server system 202. In some embodiments, the server system 300 is embodied as a cloud-based and/or SaaS-based (software as a service) architecture. In one embodiment, the server system 300 is a part of the blockchain payment network 214. The server system 300 is configured to classify and determine fraudulent transactions in digital asset transactions using a machine learning model without temporal bias.

In one embodiment, the server system 300 includes a computer system 302 and a database 304. The computer system 302 includes at least one processor 306 for executing instructions, a memory 308, and a communication interface 310. The one or more components of the computer system 302 communicate with each other via a bus 312.

In some embodiments, the database 304 is integrated within computer system 302. For example, the computer system 302 may include one or more hard disk drives as the database 304. A storage interface 314 is any component capable of providing the processor 306 with access to the database 304. The storage interface 314 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 306 with access to the database 304.

The processor 306 includes suitable logic, circuitry, and/or interfaces to execute computer-readable instructions for classifying and determining illicit or fraudulent digital asset transactions. Examples of the processor 306 include, but are not limited to, an application-specific integrated circuit (ASIC) processor, a reduced instruction set computing (RISC) processor, a complex instruction set computing (CISC) processor, a graphical processing unit (GPU) processor, a field-programmable gate array (FPGA), and the like. The memory 308 includes suitable logic, circuitry, and/or interfaces to store a set of computer-readable instructions for performing operations. Examples of the memory 308 include a random-access memory (RAM), a read-only memory (ROM), a removable storage drive, a hard disk drive (HDD), and the like. It will be apparent to a person skilled in the art that the scope of the disclosure is not limited to realizing the memory 308 in the server system 300, as described herein. In another embodiment, the memory 308 may be realized in the form of a database server or cloud storage working in conjunction with the server system 300, without departing from the scope of the present disclosure.

The processor 306 is operatively coupled to the communication interface 310 such that the processor 306 is capable of communicating with a remote device 316 such as the user device 204, the merchant device 208, the transaction analyzing unit 212, the blockchain payment network 214, or communicated with any entity connected to the network 220 (as shown in FIG. 1). It is noted that the server system 300 as illustrated and hereinafter described is merely illustrative of an apparatus that could benefit from embodiments of the present disclosure and, therefore, should not be taken to limit the scope of the present disclosure. It is noted that the server system 300 may include fewer or more components than those depicted in FIG. 3.

In one embodiment, the processor 306 includes a data pre-processing engine 318, a GNN feature extractor 320, a fraud classifier 322, and a timestep classifier 324. It should be noted that the components, described herein, can be configured in a variety of ways, including electronic circuitries, digital arithmetic and logic blocks, and memory systems in combination with software, firmware, and embedded technologies. In an embodiment, the database 304 includes a detection model 326, a fraud model 328, and a timestep model 330. It should be noted that the detection model 326, fraud model 328, and timestep model 330 of FIG. 3 are similar to the detection model 112, fraud model 114, and timestep model 116 of FIG. 1, respectively.

The data pre-processing engine 318 includes suitable logic and/or interfaces for accessing digital asset transaction data associated with a plurality of digital asset payment transactions performed historically over the blockchain payment network 214. The data pre-processing engine 318 is configured to generate a plurality of transaction graphs based on the digital asset transaction data. In one embodiment, the plurality of transaction graphs is generated by the transaction analyzing unit 212. It should be understood that each of the plurality of transaction graphs includes a plurality of nodes and a plurality of edges. The plurality of nodes may correspond to a plurality of digital asset transactions and the plurality of edges may correspond to different entities involved in the plurality of digital asset transactions such as the user 206 and the merchant 210.

The graph neural network (GNN) feature extractor 320 includes suitable logic and/or interfaces for learning topological features of the plurality of transaction graphs in a semi-supervised manner. In a non-limiting example, the graph neural network (GNN) feature extractor 320 may use the detection model 326 to perform its operations. The detection model 326 may be an AI model or an ML model. The detection model 326 is configured to generate a set of embeddings, hidden representations, or intermediate node representations corresponding to each transaction node of the transaction graph. The detection model 326 is configured to capture the raw features of the transaction graph and learn the representations and enhance the representations to generate feature-rich representations of the transaction graph.

In general, the detection model 326 may be a graph neural network model that is capable of directly operating on the transaction graph structure. As may be understood, a typical application of the GNN model is node classification. In one example, the GNN model may be based on a Deepwalk model, a GraphS age model, a node2vec, etc, among other suitable models. In the node classification problem setup, each node ‘v’ is characterized by its feature ‘x_v’ and associated with a ground-truth label ‘t_v’. Given a partially labeled graph ‘G’, the goal of the GNN model is to leverage these labeled nodes to predict the labels of the unlabeled nodes. That is, the GNN model learns to represent each node with a dimensional vector (state) ‘h_v’ that contains the information of its neighborhood.

The detection model 326 is configured to generate the set of intermediate node representations of each transaction node to the fraud classifier 322 and the timestep classifier 324. In an embodiment, fraud classifier 322 includes a fraud model 328, and the timestep classifier 324 includes a timestep model 330.

The detection model 326 is trained based on the loss values of both the fraud and timestep models 328, and 330 in an adversarial manner such that the fraud model 328 is optimized to classify the fraud labels correctly and the timestep model 330 is optimized to classify the timestep incorrectly. The combination of the fraud classification loss and the reverse gradient polarity of the timestep classification loss is back propagated to determine or fine-tune an adversarial loss value. Alternatively, the detection model 326 is trained by fine-tuning the weights based on backpropagation values from the previous epoch of the fraud model 328 and the timestep model 330. In an alternative embodiment, a set of optimized parameters may be generated for the detection model 326 based at least in part on the adversarial loss value. Further, these optimized parameters are used to generate an optimized machine learning model (referred to hereafter as ‘optimized detection model’). The optimized detection model is configured to generate a set of updated intermediate node representations associated with each of the plurality of transaction nodes. Further, the fraud model 328 may use the set of updated intermediate node representations to classify a digital asset transaction as either licit or illicit.

In a non-limiting example, the fraud model 328 may be a fully connected layer based classification model with a softmax layer that predicts the class (i.e., licit, illicit, or unknown) of the transaction node by consuming the intermediate node representations generated by the detection model 326.

The fraud classifier 322 includes suitable logic and/or interfaces for classifying the digital transaction datasets into licit and illicit transactions based on a combination of the feature-rich representation of attributes based on the transaction graph and the fraud model 328. The fraud model 328 is provided with a feature-rich representation of attributes based on the transaction graph as an input and the fraud model 328 outputs a predicted class of transactions with a loss function. In one embodiment, the loss function is a categorical cross-entropy loss.

During the training phase, the fraud model 328 is trained based, at least in part, on the training data. The training data includes a plurality of digital asset transaction datasets which consists of feature-rich representation of attributes based on the transaction graph as input. The fraud model 328 classifies the feature-rich representation of attributes into licit transactions and illicit transactions. In some embodiments, the classification model of the fraud model 328 may be, but is not limited to, perceptron, Naive Bayes, decision tree, logistic regression, K-Nearest neighbor, artificial neural networks/deep learning, support vector machine, and the like.

The timestep classifier 324 includes suitable logic and/or interfaces for classifying the digital asset transaction datasets into time steps based on a combination of the feature-rich representation of attributes based on the transaction graph and a timestep model 330. The timestep model 330 may be an example of a fully-connected layer based classification model with a softmax layer. The classification model is provided with a feature-rich representation of attribute based on the transaction graph as an input and the output of classification model predicts to which timestep each transaction node belongs to and with a loss function. In one embodiment, the loss function is a categorical cross-entropy loss.

During the training phase, the timestep model 330 is trained based, at least in part, on the training data. The training data includes a plurality of digital asset transaction datasets which consist of feature-rich representation of attribute based on the transaction graph as an input. The timestep model 330 predicts the timestep associated with the feature-rich representation of attribute based on the transaction graph. In some embodiments, the classification model of the timestep model 330 may be, but is not limited to, perceptron, Naive Bayes, decision tree, logistic regression, K-Nearest neighbor, artificial neural networks/deep learning, support vector machine, and the like.

In an embodiment, to show that features are time specific in nature, a random forest model (RF) is trained separately, first on the set of local features (LF), then on the set of aggregated features (AF), and at last on both the set of local and the set of aggregated features combined (RF: LF+AF). The RF model can effectively predict the respective timestep associated with transaction features. The RF model trained on aggregated features may predict the corresponding timestep with almost certainty and to reduce the time bias, the temporal de-biased classification model based node embedding using both the set of local and the set of aggregated features is used. In one embodiment, the RF model (RF^{NE}) is trained using the embeddings/intermediate node representations to predict the associated timestep. The results for RF^{NE} in Table 1 demonstrate that the time bias in these node embedding features is significantly less compared to other features and the temporal de-biased classification model can reduce the time bias in features by 70%.

TABLE 1
Timestep Prediction Accuracy

| Model | Overall | Licit Nodes | Illicit Nodes |
|---|---|---|---|
| RF^{LF} | 0.595 | 0.583 | 0.712 |
| RF^{AF} | 0.995 | 0.994 | 0.996 |
| RF^{LF+AF} | 0.988 | 0.988 | 0.995 |
| RF^{NE} | 0.299 | 0.307 | 0.229 |

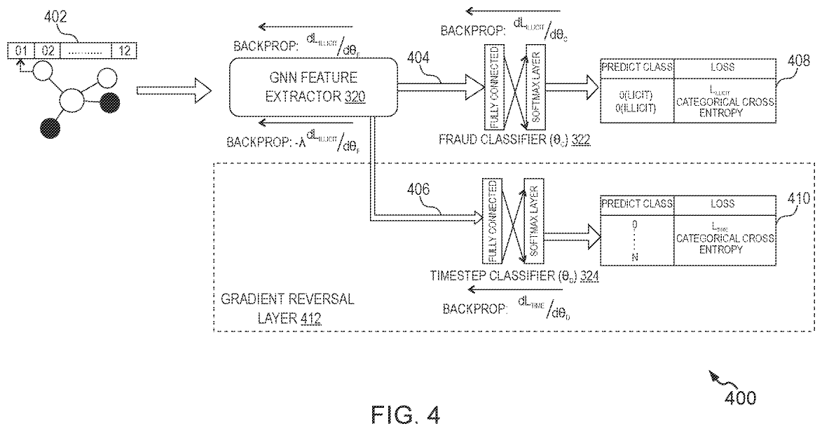

Referring now to FIG. 4, a schematic block diagram representation 400 of various models for detecting illicit digital asset transactions is illustrated, in accordance with an embodiment of the present disclosure. In one embodiment, a gradient reversal layer is introduced to remove temporal biases in the GNN feature extractor 320.

As mentioned earlier, the server system 300 is configured to access digital asset transaction data of a plurality of digital asset transactions for different time steps and generate a transaction graph associated with each timestep.

The set of local and aggregated features of each temporal transaction graph is provided to the GNN feature extractor 320 (see, 402). The GNN feature extractor 320 implements the detection model 326 which may be a graph neural network (GNN) model.

It should be noted that graph neural network (GNN) models are well known for their capability for encoding the topological structure and node features in graph based data to an intermediate node representation.

In an illustrated example, given a transaction node ‘nᵢ’, such that nᵢ∈N, where N is a set of all digital asset transactions in an exemplary transaction dataset. Further, the node nᵢ features may be represented by Xᵢ^{p}∈X→R^{n×p} of length p. To inspect the temporal bias, the timestep T′ of the digital asset transaction is inspected using the features, X. This classification task is defined by the equation below:

Cₜᵢₘₑₛₜₑₚ: X→T′ Eqn. (1)

Based on the results shown early in Table 1, it is concluded that both the set of local features and the set of aggregate features are temporally biased. To address this temporal bias, the detection model 326 needs to be trained without any temporal bias.

To that end, given a digital asset transaction dataset U=[(n₁, n₃, t₁), (n₃, n₄, t₁), . . . (nᵢ, nⱼ, tₖ)]_{i≠j}, nᵢ∈N, where N is a set of total ‘n’ nodes and tₖ∈T, where T is a set of total ‘t’ timesteps for which the data is collected. Here, each tuple represents two nodes nᵢ and nⱼ interacting at a particular time step tₖ can be visualized in the form of a graph data G=(N, E). Each node nᵢ has a feature vector Xᵢ^{p}∈X→R^{n×p} of length p. Further, transaction nodes N can either be labeled as licit or illicit by (nᵢ, yᵢ) E (N_{lab}, Y), Y→{0, 1} or unlabelled nⱼ∈N_{unlab}. The graph ‘G’ has an adjacency matrix A→{0, 1}^{n×n}, where aᵢⱼ∈A represents whether there is an edge between nodes nᵢ and nⱼ. Since it's a directed graph, aᵢⱼ≠aⱼᵢ.

Then, for graph ‘G’, feature matrix ‘X’ and an adjacency matrix ‘A’ may be provided to the GNN based model, i.e., the detection model 326. In response, the model generates an output including a new embedding (i.e., intermediate node representation) H→R^{n×d} where ‘d’ is the size of the output embedding. Further, the detection model 326 of the GNN feature extractor 320 is defined with a learnable parameter θ_{f} as shown below:

f_{fea_ext}(θ_{f}):G(A,X)→H Eqn. (2)

In one embodiment, the GNN feature extractor 320 is a graph convolutional network (GCN) feature extractor and/or graph attention network (GAT) feature extractor. The GCN feature extractor and the GAT feature extractor both are excellent at extracting topological features in a graph-based data in a semi-supervised setting. The GCN feature extractor computes features based on the isotropic aggregation method, while the GAT feature extractor computes features based on an anisotropic aggregation method which provides different weightage to nodes during aggregation. In another embodiment, illicit transactions in digital transaction datasets are generally determined using the attributes of the neighboring transactions. The output of the detection model 326 of the GNN feature extractor 320 is a set of intermediate node representations or embeddings for each transaction node. This output set of intermediate node representations is passed as an input to the fraud classifier 322 and the timestep classifier 324. The fraud classifier 322 implements the fraud model 328 and the timestep classifier implements the timestep model 330. The outputs of the fraud model 328 and the timestep model 330 are used to generate optimizations for the detection model 326. In an alternative embodiment, the outputs of the fraud model 328 and the timestep model 330 are used to generate an optimized detection model from the detection model 326. Further, the optimized detection model is used to generate a set of updated intermediate node representations that may be used by the fraud model 328 to classify digital asset transactions as licit or illicit without any temporal bias, thus providing a robust mechanism for detecting fraudulent or illicit digital asset transactions.

In one embodiment, the set of hidden or intermediate node representations generated by the detection model 326 of the GNN feature extractor 320 is provided to the fraud classifier 322 (see, 404). The fraud model 328 of the fraud classifier 322 classifies the set of intermediate node representations of each node of the plurality of transaction graphs into licit transactions and illicit transactions. The fraud model 328 is fully connected (fc) layers based neural network architecture. In particular, the fully connected (fc) layers based neural network architecture includes a convolutional neural network (e.g., 2×2 CNN filter) fully operating on a feature rich input, wherein each input is connected to all neurons present in the fc layer based neural network architecture. The fraud model 328 further consists of a softmax layer which includes a softmax function that turns a vector of K real values into a vector of K real values that sum to 1. The fraud model 328 consumes node embedding from the feature rich representations from detection model 326 to output the predictive class data. The single dimension numerical representation output of the fraud model 328 is used to generate a classification score followed by loss calculation L_{fraud}. In one embodiment, the classification model is further trained based on a loss function where the loss function is a categorical cross-entropy loss (i.e., L_{fraud}).

In one embodiment, the fraud model 328 provides classification output 408, where the fraud model 328 predicts the class of the digital asset transaction datasets into licit and illicit classes. The ‘0’ represents the licit class and the ‘1’ represents the illicit classes. The fraud classifier 322 is parameterized by θ_{c} as:

C_{fraud}(θ_{c}):H→Y,Y∈{0,1} Eqn. (3)
where, 0 represents the licit transaction and the 1 represents the illicit transaction.

The fraud categorical cross entropy loss is defined as:

L_{fraud}ⁿ^{ᵢ}(θ_{f},θ_{c})=L_{fraud}(C_{fraud}(F_{feat_ext}(G;θ_{f});θ_{c}),yᵢ),(nᵢ,yᵢ)∈N_{lab} Eqn. (4)

In one embodiment, the detection model 326 of GNN feature extractor 320 is also configured to provide the set of intermediate node representations of each transaction node to the timestep classifier 324 (see, 406). The timestep model 330 predicts the timestep of the transaction node. The single dimension numerical representation output 410 of the timestep model 330 is used to generate a timestep classification score followed by loss calculation Lₜᵢₘₑ.

In one embodiment the timestep model 330 provides the representation output 410 of the timestep model 330. The timestep classifier 324 is parameterized by θ_{d} as:

Cₜᵢₘₑₛₜₑₚ(θ_{d}):H→T,T∈{0,1, . . . t} Eqn. (5)

Where, {0, 1, . . . t} represents the time at which the cryptocurrency transaction takes place.

The timestep categorical cross-entropy loss is defined as:

Lₜᵢₘₑₛₜₑₚⁿ^{ᵢ}(θ_{f},θ_{d})=Lₜᵢₘₑₛₜₑₚ(Cₜᵢₘₑₛₜₑₚ(F_{feat_ext}(G;θ_{f});θ_{d}),tᵢ),nᵢ∈N,tᵢ∈T Eqn. (6)

In one embodiment, the timestep model 330 works as a gradient reversal layer (GRL) 412 for eliminating timestep bias in determining illicit transactions. The total loss L is defined as:

L(θ_{f},θ_{c},θ_{d})=Σₙ_{ᵢ}_{∈N}_{_{lab}}L_{fraud}ⁿ^{ᵢ}−Σₙ_{ᵢ}_{∈N}λLₜᵢₘₑₛₜₑₚⁿ^{ᵢ}λ∈[0,1] Eqn. (7)

The gradient reversal layer 412 is an identity function that outputs same as the input during forward propagation and multiplies its input by −1 during back propagation. The gradient reversal layer 412 reverses the polarity of the gradients of timestep categorical cross-entropy loss in the backward pass which ensures that the detection model 326 is forced to learn the weights that make the timestep model 330 perform worse as training continues, hence making the model temporally unbiased a the back propagation progresses. In an embodiment, the optimization process of the model may progress till the performance of the timestep model 330 falls below a predetermined threshold. In a non-limiting example, the predetermined threshold may be established by an administrator of the detection model 326 or by a payment processor operating the detection model 326.

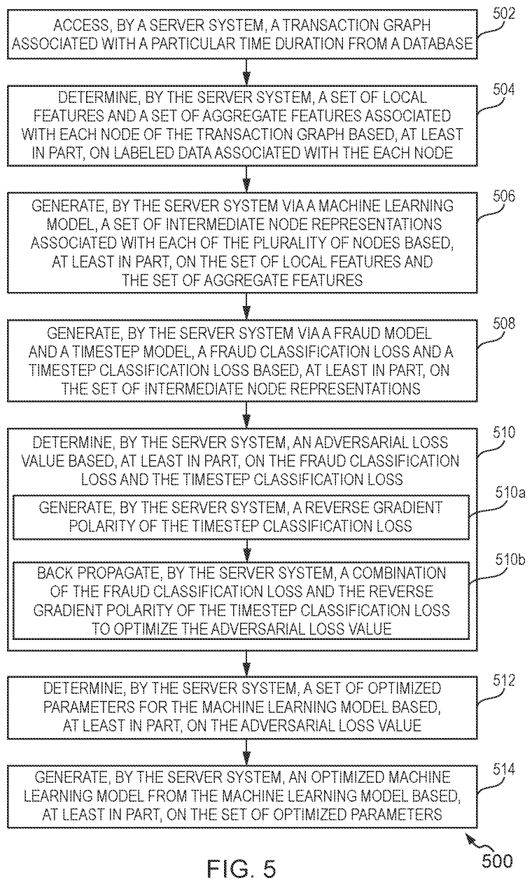

FIG. 5 illustrates a method 500 for removing temporal biases in detecting illicit transactions, in accordance with an embodiment of the present disclosure. The sequence of operations of the method 500 may not be necessarily executed in the same order as they are presented. Further, one or more operations may be grouped together and performed in form of a single step, or one operation may have several sub-steps that may be performed in parallel or in a sequential manner.

At 502, the method 500 includes accessing, by a server system 300, a transaction graph associated with a particular time duration from a database 304. The transaction graph includes at least a plurality of nodes and a plurality of edges. The plurality of nodes may correspond to a plurality of transactions and the plurality of edges may correspond to different entities involved in the plurality of transactions. In a non-limiting example, the different entities may include at least one of a user 206 and a merchant 210.

At 504, the method 500 includes determining, by the server system 300, a set of local features and a set of aggregate features associated with each node of the transaction graph based, at least in part, on labeled data associated with the each node. The labeled data includes at least a set of information associated with each of the plurality of nodes.

At 506, the method 500 includes generating, by the server system 300 via a machine learning model, a set of intermediate node representations associated with each of the plurality of nodes based, at least in part, on the set of local features and the set of aggregate features. In an embodiment, the machine learning model is the detection model 326. In particular, the machine learning model is a graph neural network (GNN) model trained in an adversarial manner or with an adversarial architecture.

At 508, the method 500 includes generating, by the server system 300 via a fraud model 328 and a timestep model 330, a fraud classification loss and a timestep classification loss based, at least in part, on the set of intermediate node representations. In an embodiment, the fraud classification loss and the timestep classification loss are categorical cross-entropy losses.

At 510, the method 500 includes determining, by the server system 300, an adversarial loss value based, at least in part, on the fraud classification loss and the timestep classification loss. In an embodiment, determining the adversarial loss value includes iteratively performing the operations till the performance of the timestep model is greater than a predetermined threshold. The operations 510a include generating, by the server system 300, a reverse gradient polarity of the timestep classification loss. The operation 510b includes back propagating, by the server system, a combination of the fraud classification loss and the reverse gradient polarity of the timestep classification loss to optimize the adversarial loss value.

At 512, the method 500 includes determining, by the server system, a set of optimized parameters for the machine learning model based, at least in part, on the adversarial loss value.

At 514, the method includes generating, by the server system, an optimized machine learning model from the machine learning model based, at least in part, on the set of optimized parameters.

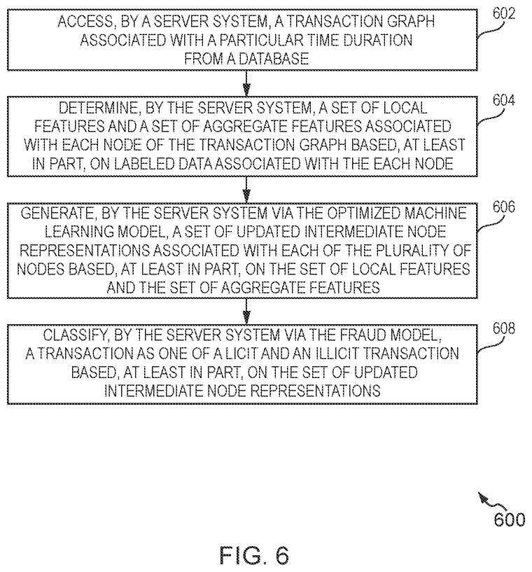

FIG. 6 is a method 600 for determining fraudulent cryptocurrency payment transactions, in accordance with an embodiment of the present disclosure. The sequence of operations of the flowchart of method 600 may not be necessarily executed in the same order as they are presented. Further, one or more operations may be grouped together and performed in form of a single step, or one operation may have several sub-steps that may be performed in parallel or in a sequential manner.

At 602, the method 600 includes accessing, by a server system 300, a transaction graph associated with a particular time duration from a database 218. The transaction graph includes at least a plurality of nodes and a plurality of edges. The plurality of nodes may correspond to a plurality of transactions and the plurality of edges may correspond to different entities involved in the plurality of transactions. In a non-limiting example, the different entities may include at least one of a user 206 and a merchant 210.

At 604, the method 600 includes determining, by the server system 300, a set of local features and a set of aggregate features associated with each node of the transaction graph based, at least in part, on labeled data associated with the each node.

At 606, the method 600 includes generating, by the server system 300 via the optimized machine learning model, a set of updated intermediate node representations associated with each of the plurality of nodes based, at least in part, on the set of local features and the set of aggregate features.

At 608, the method 600 includes classifying, by the server system 300 via the fraud model 328, a transaction as one of a licit and an illicit transaction based, at least in part, on the set of updated intermediate node representations.

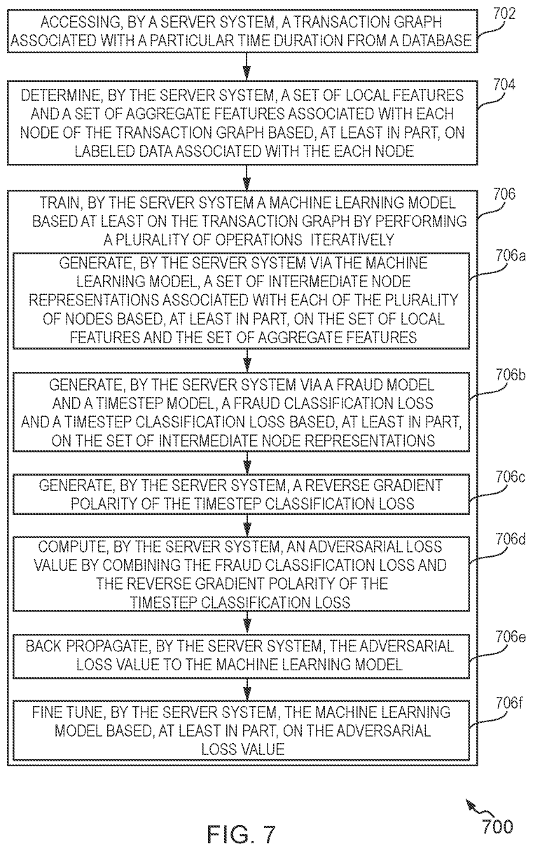

FIG. 7 illustrates a method 700 for removing temporal biases in detecting illicit transactions, in accordance with another embodiment of the present disclosure. The sequence of operations of the method 700 may not be necessarily executed in the same order as they are presented. Further, one or more operations may be grouped together and performed in form of a single step, or one operation may have several sub-steps that may be performed in parallel or in a sequential manner.

At 702, the method 700 includes accessing, by a server system 300, a transaction graph associated with a particular time duration from a database 218.

At 704, the method 700 includes determining, by the server system 300, a set of local features and a set of aggregate features associated with each node of the transaction graph based, at least in part, on labeled data associated with the each node.

At 706, the method 700 includes training, by the server system 300 a machine learning model based at least on the transaction graph by performing a plurality of operations (steps 706a-706-f) iteratively. The plurality of iterative operations is performed till the performance of the timestep model 330 is greater than a predetermined threshold. In other words, the machine learning model is trained till the timestep classification loss is greater than the predetermined threshold.

At 706a, the method 700 includes generating, by the server system 300 via the machine learning model, a set of intermediate node representations associated with each of the plurality of nodes based, at least in part, on the set of local features and the set of aggregate features.

At 706b, the method 700 includes generating, by the server system 300 via a fraud model 328 and a timestep model 330, a fraud classification loss and a timestep classification loss based, at least in part, on the set of intermediate node representations.

At 706c, the method 700 includes generating, by the server system 300, a reverse gradient polarity of the timestep classification loss.

At 706d, the method 700 includes computing, by the server system 300, an adversarial loss value by combining the fraud classification loss and the reverse gradient polarity of the timestep classification loss.

At 706e, the method 700 includes back propagating, by the server system 300, the adversarial loss value to the machine learning model.

At 706f, the method 700 includes fine tuning, by the server system, the machine learning model based, at least in part, on the adversarial loss value.

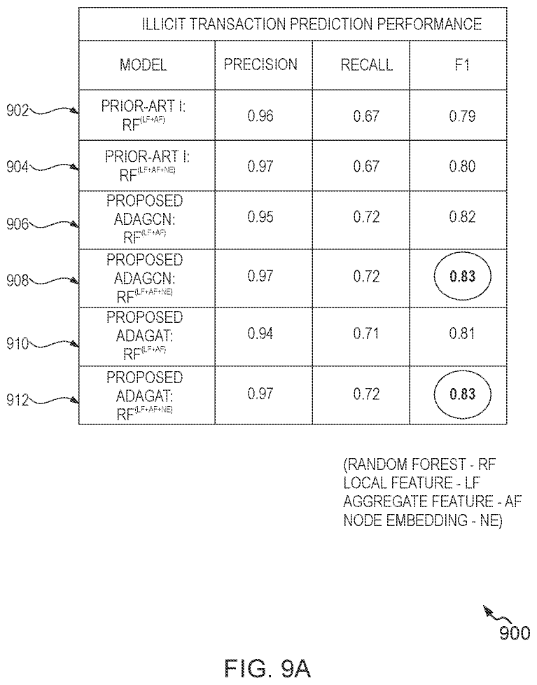

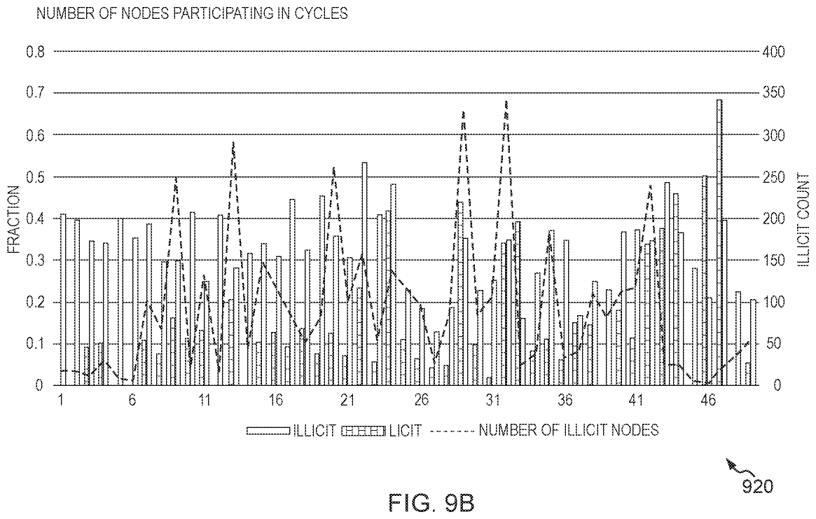

FIG. 9A shows comparative result analysis 900 of illicit classification results from experiments using prior-art models with its combination of features and node embeddings and the proposed model (i.e., the detection model 326 in accordance with the present disclosure) with its combination of features and node embeddings.

The experiments have been performed on a publicly available dataset provided by Elliptic™. Further, the results of the experiments for the prior-art models and the proposed model are tested for illicit transaction data using a Elliptic™ dataset. To show that the features of the proposed model are robust in temporal dimension, the training data and testing data are split temporally. The datasets pertaining to the first 34 timesteps is used for training the proposed model, and testing is done on the datasets of the remaining 15 timesteps. Three models i.e., prior-art model, the adaptive boosting algorithm for graph convolution networks (AdaGCN), and the adaptive boosting algorithm for graph attention networks (AdaGAT) are trained for 1000 epochs and then the node embeddings are extracted, i.e., node embeddings from GCN (NEGCN) model and node embeddings from GAT (NEGAT) model. The node embeddings (i.e., intermediate node representations), along with local features and aggregated features are used to train the multiple proposed models as shown in reference with FIG. 4

In row 902, a random forest (RF) algorithm is trained on local features (LF) and aggregate features (AF). In row 904, the RF algorithm is trained on the local features, the aggregated features, and the node embedding (NE).

In rows 906, 908, 910, and 912, the AdaGCN and AdaGAT are trained for various combination of local features, aggregated features and the node embeddings according to the proposed invention that provides higher precision in the prediction of the illicit transactions with an F1 score of 0.93 and an improvement of 5% in recall over the baseline model (see, FIG. 9B). Further, FIG. 9B depicts a graphical representation 920 of model performance of the classification model at different timesteps, in accordance with an embodiment of the present disclosure.

The disclosed method with reference to FIGS. 5 to 7, or one or more operations of the server system 300 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 300 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g. magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method comprising:
accessing, by a server system, a transaction graph associated with a particular time duration from a database, the transaction graph comprising a plurality of nodes and a plurality of edges, the plurality of nodes indicating a plurality of transactions and the plurality of edges indicating different entities involved in the plurality of transactions;
determining, by the server system, a set of local features and a set of aggregate features associated with each node of the transaction graph based, at least in part, on labeled data associated with the each node;
generating, by the server system via a machine learning model, a set of intermediate node representations associated with each of the plurality of nodes based, at least in part, on the set of local features and the set of aggregate features;
generating, by the server system via a fraud model and a timestep model, a fraud classification loss and a timestep classification loss based, at least in part, on the set of intermediate node representations;
determining, by the server system, an adversarial loss value based, at least in part, on the fraud classification loss and the timestep classification loss; and
determining, by the server system, a set of optimized parameters for the machine learning model based, at least in part, on the adversarial loss value.

2. The computer-implemented method as claimed in claim 1, wherein determining the adversarial loss value comprises iteratively performing the steps till the performance of the timestep model is greater than a predetermined threshold:
generating, by the server system, a reverse gradient polarity of the timestep classification loss; and
back propagating, by the server system, a combination of the fraud classification loss and the reverse gradient polarity of the timestep classification loss to optimize the adversarial loss value.

3. The computer-implemented method as claimed in claim 1, wherein the labeled data comprises at least a set of information associated with each of the plurality of nodes.

4. The computer-implemented method as claimed in claim 1, further comprising:
generating, by the server system, an optimized machine learning model from the machine learning model based, at least in part, on the set of optimized parameters.

5. The computer-implemented method as claimed in claim 4, further comprising:
generating, by the server system via the optimized machine learning model, a set of updated intermediate node representations associated with each of the plurality of nodes based, at least in part, on the set of local features and the set of aggregate features; and
classifying, by the server system via the fraud model, a transaction as one of a licit and an illicit transaction based, at least in part, on the set of updated intermediate node representations.

6. The computer-implemented method as claimed in claim 1, wherein the plurality of transactions is digital asset transactions performed over a blockchain network.

7. The computer-implemented method as claimed in claim 1, wherein the different entities include at least one of a customer and a merchant.

8. The computer-implemented method as claimed in claim 1, wherein the set of local features comprises at least timestep information, transaction fee, number of inputs or outputs, output volume, average asset amount received by the input or output and average incoming transactions associated with the input or output.

9. The computer-implemented method as claimed in claim 1, the set of aggregate features is determined based, at least in part, on transaction information of one transaction backward and forward from each of the plurality of nodes.

10. The computer-implemented method as claimed in claim 1, the set of aggregate features comprises at least maximum deviation, minimum deviation, standard deviation and correlation coefficients of neighbor transactions for each of the set of local features.

11. The computer-implemented method as claimed in claim 1, wherein the machine learning model is a graph neural network (GNN) model trained in an adversarial manner.

12. The computer-implemented method as claimed in claim 1, wherein the fraud model and the timestep model are fully-connected layer based classification models with a softmax layer.

13. The computer-implemented method as claimed in claim 1, wherein the server system is a payment server in a payment network.

14. A server system, comprising:
a communication interface;
a memory comprising executable instructions; and
a processor communicably coupled to the communication interface and the memory, the processor configured to execute the instructions to cause the server system, at least in part, to:
access a transaction graph associated with a particular time duration from a database, the transaction graph comprising a plurality of nodes and a plurality of edges, the plurality of nodes indicating a plurality of transactions and the plurality of edges indicating different entities involved in the plurality of transactions;
determine a set of local features and a set of aggregate features associated with each node of the transaction graph based, at least in part, on labeled data associated with the each node;
generate via a machine learning model, a set of intermediate node representations associated with each of the plurality of nodes based, at least in part, on the set of local features and the set of aggregate features;
generate via a fraud model and a timestep model, a fraud classification loss and a timestep classification loss based, at least in part, on the set of intermediate node representations;
determine an adversarial loss value based, at least in part, on the fraud classification loss and the timestep classification loss; and
determine a set of optimized parameters for the machine learning model based, at least in part, on the adversarial loss value.

15. The server system of claim 14, wherein for determining the adversarial loss value the server system to further caused to iteratively perform the steps till the performance of the timestep model is greater than a predetermined threshold:
generate a reverse gradient polarity of the timestep classification loss; and
back propagate a combination of the fraud classification loss and the reverse gradient polarity of the timestep classification loss to optimize the adversarial loss value.

16. The server system of claim 14, wherein the server system is further caused, at least in part, to:
generate an optimized machine learning model from the machine learning model based, at least in part, on the set of optimized parameters.

17. The server system of claim 16, wherein the server system is further caused, at least in part, to:
generate via the optimized machine learning model, a set of updated intermediate node representations associated with each of the plurality of nodes based, at least in part, on the set of local features and the set of aggregate features; and
classify via the fraud model, a transaction as one of a licit and an illicit transaction based, at least in part, on the set of updated intermediate node representations.

18. A non-transitory computer-readable storage medium comprising computer-executable instructions that, when executed by at least a processor of a server system, cause the server system to perform a method comprising:
accessing a transaction graph associated with a particular time duration from a database, the transaction graph comprising a plurality of nodes and a plurality of edges, the plurality of nodes indicating a plurality of transactions and the plurality of edges indicating different entities involved in the plurality of transactions;
determining a set of local features and a set of aggregate features associated with each node of the transaction graph based, at least in part, on labeled data associated with the each node;
generating via a machine learning model, a set of intermediate node representations associated with each of the plurality of nodes based, at least in part, on the set of local features and the set of aggregate features;
generating via a fraud model and a timestep model, a fraud classification loss and a timestep classification loss based, at least in part, on the set of intermediate node representations;
determining an adversarial loss value based, at least in part, on the fraud classification loss and the timestep classification loss; and
determining a set of optimized parameters for the machine learning model based, at least in part, on the adversarial loss value.

19. The non-transitory computer-readable storage medium as claimed in claim 18, wherein determining the adversarial loss value comprises iteratively performing the steps till the performance of the timestep model is greater than a predetermined threshold:
generating a reverse gradient polarity of the timestep classification loss; and
back propagating a combination of the fraud classification loss and the reverse gradient polarity of the timestep classification loss to optimize the adversarial loss value.

20. The non-transitory computer-readable storage medium as claimed in claim 18, further comprises
generating an optimized machine learning model from the machine learning model based, at least in part, on the set of optimized parameters;
generating, by the server system via the optimized machine learning model, a set of updated intermediate node representations associated with each of the plurality of nodes based, at least in part, on the set of local features and the set of aggregate features; and
classifying, by the server system via the fraud model, a transaction as one of a licit and an illicit transaction based, at least in part, on the set of updated intermediate node representations.
